(19) United States
(12) Patent Application Publication
(10) Pub. No.: US 2021/0408539 A1
(43) Pub. Date: Dec. 30, 2021

(54) Coated Cathode For Solid State Batteries

(71) Applicants: Northeastern University, Boston, MA (US); Worcester Polytechnic Institute, Worcester, MA (US)

(72) Inventors: Hongli Zhu, Arlington, MA (US); Yubin Zhang, Worcester, MA (US); Yan Wang, Shrewsbury, MA (US); Daxian Cao, Boston, MA (US)

(21) Appl. No.: 17/363,693

(22) Filed: Jun. 30, 2021

Related U.S. Application Data
(60) Provisional application No. 63/046,689, filed on Jun. 30, 2020.

(51) Int. Cl. H01M 4/525; H01M 4/505; H01M 10/0562; H01M 4/04

(52) U.S. Cl. CPC H01M 4/525; H01M 4/505; H01M 2300/008; H01M 4/0457; H01M 4/0471; H01M 10/0562

(57) ABSTRACT

A solid-state battery is described. The solid-state battery includes an anode, a coated cathode, and an electrolyte. The cathode coating is formed of lithium (Li), lanthanum (La), strontium (Sr), titanium (Ti), and oxygen (O). The cathode coating has a high ionic conductivity.

### RELATED APPLICATION

This application claims the benefit of U.S. Provisional Application No. 63/046,689, filed on Jun. 30, 2020. The entire teachings of the above application are incorporated herein by reference.

### GOVERNMENT SUPPORT

This invention was made with government support under Grant No. 1924534 awarded by the National Science Foundation. This invention was made with government support under Grant No. 1608398 awarded by the National Science Foundation. The government has certain rights in the invention

### BACKGROUND

All-solid-state lithium batteries (ASLBs) are promising for the next generation energy storage system with critical safety. Among various candidates, thiophosphate-based electrolytes have shown great promise because of their high ionic conductivity. However, the narrow operation voltage and poor compatibility with high voltage cathode materials impede their application in the development of high energy ASLBs.

### SUMMARY

In this work, we studied the failure mechanism of Li₆PS₅Cl at high voltage through in situ Raman spectra and investigated the stability with high-voltage LiNi_{1/3}Mn_{1/3}Co_{1/3}O₂ (NMC) cathode. With a facile wet chemical approach, we coated a thin layer of amorphous Li_{0.35}La_{0.5}Sr_{0.05}TiO₃ (LLSTO) with 15-20 nm at the interface between NMC and Li₆PS₅Cl. We studied different coating parameters and optimized the coating thickness of the interface layers. Meanwhile, we studied the effect of NMC dimension to the ASLBs performance. We further conducted the first-principles thermodynamic calculations to understand the electrochemical stability between Li₆PS₅Cl and carbon, NMC, LLSTO, NMC/LLSTO. Attributed to the high stability of Li₆PS₅Cl with NMC/LLSTO and outstanding ionic conductivity of the LLSTO and Li₆PS₅Cl, at room temperature, the ASLBs exhibit outstanding capacity of 107 mAh g⁻¹ and keep stable for 850 cycles with a high capacity retention of 91.5% at C/3 and voltage window 2.5-4.0 V (vs Li—In).

Described herein is a solid-state battery. The battery includes a) an anode; b) a coated cathode; and c) an electrolyte. The anode includes lithium (Li) and indium (In). The cathode includes lithium (Li). The cathode coating includes lithium (Li), lanthanum (La), strontium (Sr), titanium (Ti), and oxygen (O). The electrolyte includes phosphorus (P) and sulfur (S).

The cathode coating can include Li_{0.35}La_{0.5}Sr_{0.05}TiO₃. The cathode coating can have a thickness of about 15 nm to about 20 nm. The cathode coating can have an ionic conductivity of about 10⁻⁴ S cm⁻¹ to about 10⁻⁵ S cm⁻¹ at 30° C.

The cathode can include LiCoO₂.

The cathode can further include nickel (Ni), manganese (Mn), cobalt (Co), and oxygen (O). The cathode can include LiNi_{1/3}Mn_{1/3}Co_{1/3}O₂ (NMC 111). The cathode can include LiNi_{0.5}Co_{0.1}Mn_{0.1}O₂ (NMC 811) or LiNi_{0.5}Mn_{0.3}Co_{0.2}O₂ (NMC 532).

The electrolyte can include Li₆PS₅Cl.

The battery can have a capacity of at least 100 mAh g¹. The battery can have an initial Coulombic efficiency of at least 70%. The battery can retain at least 90% of its original capacity after 850 cycles. The battery can have a capacity retention of at least 91% at C/3. The battery can have a voltage window from about 2.5 V versus Li—In to about 4.0 V versus Li—In.

Described herein is a coated cathode. The cathode includes lithium (Li). The cathode coating includes lithium (Li), lanthanum (La), strontium (Sr), titanium (Ti), and oxygen (O). The cathode coating can include Li_{0.35}La_{0.5}Sr_{0.05}TiO₃. The cathode coating can have a thickness of about 15 nm to about 20 nm. The cathode coating can have an ionic conductivity of about 10-4 S cm⁻¹ to about 10⁻⁵ S cm⁻¹ at 30° C.

The cathode can include LiCoO₂.

The cathode can further include nickel (Ni), manganese (Mn), cobalt (Co), and oxygen (O). The cathode can include LiNi_{1/3}Mn_{1/3}Co_{1/3}O₂ (NMC 111). The cathode can include LiNi_{0.5}Co_{0.1}Mn_{0.102} (NMC 811) or LiNi_{0.5}Mn_{0.3}Co_{0.2}O₂ (NMC 532).

Described herein is a method of making a coated cathode. The method includes: a) forming a sol; b) mixing a dried powder that includes lithium, nickel, manganese, cobalt, and oxide with the sol to form a suspension; c) mixing the suspension; d) allowing a gel to form; and e) calcining and sintering sintering the gel to form a coated cathode material. Forming the sol includes: i) mixing lithium isopropoxide, lanthanum 2 methoxyethoxide, titanium isopropoxide, and strontium isopropoxide in an inert atmosphere; ii) refluxing; and iii) adding water.

Forming the sol can include mixing lithium isopropoxide, lanthanum 2 methoxyethoxide, titanium isopropoxide, and strontium isopropoxide according to a stoichiometric ratio of Li_{0.35}La_{0.5}Sr_{0.05}TiO₃. Forming the sol can include mixing at least 10% mol excess lithium isopropoxide. Forming the sol can include adding at least 10 mol % water. The dried powder can be mixed with the sol according to a ratio of 1 g NMC/0.25 mMol LLSTO.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a schematic of the configuration of ASLBs with/without interface engineering. FIG. 1B is a schematic of the failure mechanism at the interface in bare NMC-based ASLBs. FIG. 1C is a schematic of interface stabilization with LLSTO layer.

FIG. 2A is a schematic of the method for coating LLSTO on NMC. FIG. 2B is a surface SEM image of bare NMC. FIG. 2C is a surface SEM image of NMC-LLSTO. FIG. 2D is an XRD of NMC, LLSTO, and NMC-LLSTO. FIG. 2E is an SEM image of the NMC-LLSTO. FIG. 2F is and elemental mapping of Ni of the NMC-LLSTO. FIG. 2G is an elemental mapping of Ti of the NMC-LLSTO. FIGS. 2H-J are a TEM image (FIG. 2H), elemental mapping (FIG. 2I), and EDX spectrum (FIG. 2J) of NMC-LLSTO to show the presence of Sr, Ti, and La elements.

FIGS. 3A-E are an investigation of the stability of Li₆PS₅Cl at the oxidation process. FIG. 3A is a schematic of the cell setup for in situ Raman measurement. FIG. 3B is CV curves in the first five cycles. FIG. 3C is Raman spectra in different oxidation process. FIG. 3D is first-principles computation results of the voltage profile and the phase equilibria of Li₆PS₅Cl solid electrolyte upon lithiation and delithiation. FIG. 3E is a schematic of degradation of Li₆PS₅Cl at the interface with carbon.

FIGS. 4A-H show the electrochemical performance of ASLBs with bare NMC and NMC-LLSTO cathodes. The charge/discharge profiles of bare NMC (FIG. 4A) and NMC-LLSTO (FIG. 4B) in the initial three cycles at C/10. The comparison in overpotential after one cycle is highlighted. FIG. 4C is Nyquist plots of bare NMC and NMC-LLSTO before and after one cycle. The inset shows the magnified plots. Transient voltage profiles (FIG. 4D) and diffusion coefficient versus depth of discharge (FIG. 4E) of bare NMC and NMC-LLSTO. FIG. 4F shows long-term cycling performance of bare NMC and NMC-LLSTO with mass loading of 7.9 mg cm⁻² at C/3. FIG. 4G shows rate performance of bare NMC and NMC-LLSTO. FIG. 4H shows cycling performance of NMC-LLSTO with high mass loading of 20 mg cm⁻² at C/3. All ASLBs are performed in room temperature.

FIG. 5 shows calculated mutual reaction energies of the bare NMC-Li₆PS₅Cl, NMC-LLSTO, and LLSTO-Li₆PS₅Cl interfaces. The most exothermic mutual reaction energy is between the bare NMC and Li₆PS₅Cl, whereas the interfaces with LLSTO are more stable with much less favorable reaction energies.

FIG. 6 is a Nyquist plot of LLSTO. Inset shows the equivalent circuit.

FIG. 7A is XRD patterns of Li₆PS₅Cl. The bumped peak was derived from the Kapton tape for sample protection. FIG. 7B is Nyquist plots and fit result of Li₆PS₅Cl. Inset shows the zooming in image at high frequency and equivalent circuit.

FIG. 8 shows the transient voltage profiles in one discharge pulse for NMC-LLSTO and Bare NMC.

FIGS. 9A-B show the morphology of NMC-LLSTO without (FIG. 9A) and with (FIG. 9B) gel-forming process.

FIGS. 10A-L are SEM images showing the morphology of NMC with different coating thickness. The morphology of NMC#3 is shown in FIG. 2B.

FIGS. 11A-C show the electrochemical performance of NMC with different coating thickness.

FIGS. 12A-C show the morphology of NMC after ball milling. FIG. 12D shows the electrochemical performance of NMC by coating first and then ball milling. FIG. 12E shows the electrochemical performance of NMC by ball milling first and then applying coating.

FIGS. 13A-B show the charge/discharge profiles of Bare NMC (FIG. 13A) NMC-LLSTO (FIG. 13B) at different rates.

### DETAILED DESCRIPTION

A description of example embodiments follows.

Safety concerns of conventional lithium ion batteries (LIBs) with organic liquid electrolyte have increased due to their flammability and frequently reported accidents.^{1,2} All-solid-state lithium batteries (ASLBs) have been considered as a solution to effectively address the safety issue.³ Furthermore, when matched with Li metal anode, ASLBs are expected to have much higher energy density than the state-of-the-art LIB (<260 Wh kg⁻¹).^{4,5} Therefore, ASLBs has attracted broad attention from academia to industry and government agencies.⁶ In particular, highlighted with ionic conductivity comparable with liquid electrolyte and high mechanical deformability, thiophosphate-based solid-state electrolytes (SEs) are one of the most promising electrolytes for high-energy ASLBs working at room temperature.^{5,7} In contrast, most reported ASLBs using polymer- and oxide-based SEs still need external heating or adding liquid electrolyte to achieve optimal behavior.^{8,9}

To achieve high-energy-density batteries, layered Li—Ni_{1/3}Mn_{1/3}Co_{1/3}O₂ (NMC) is one of the most attractive cathode candidates due to high working potential (>3.6 V), promising capacity (˜160 mAh g⁻¹), relatively high electron conductivity (˜10⁻⁵ S cm⁻¹), and Li-ion diffusivity (˜10⁻¹¹ cm² s⁻¹).^{10,11} However, thiophosphate-based electrolytes suffer from severe interfacial instability with NMC cathode in ASLBs which leads to significant capacity loss, poor power density, and short cycling life.^{12,13} The poor interface stability is caused by a narrow thermodynamic intrinsic electrochemical stability window of sulfide SE ranging from 1.7 to 2.3 V (versus Li⁺/Li) and the tendency for the NMC cathode to oxidize the sulfide electrolyte in physical contact, in particular at high charging potential.^{14,15} These thermodynamically favorable reactions decompose the solid electrolyte into passivated products with poor ionic conductivity, which causes significant interfacial resistance. Electronically conductive additives mixed into the cathode accelerate this decomposition.^{16,17} The irreversible reaction causes a high initial capacity loss and low Coulombic efficiency.¹⁸ Consequently, the energy and power density has been significantly limited.

To resolve this incompatibility issue between sulfide SEs and high-energy oxide cathodes, a thin protective oxide coating layer, such as LiNbO₃, Li₄Ti₅O₁₂, Li₂SiO₃, and Li₃PO₄, is employed to avoid the direct contact of SE and cathode.¹⁹⁻²³ Although this oxide coating can stabilize the interfaces, current interlayer materials often possess relative poor ionic conductivity ranging from 10⁻⁹ to 10⁻⁶ S cm⁻¹ and require expensive coating techniques such as pulsed laser deposition (PLD).²⁴ A key challenge for high-energy ASLBs is to develop a buffer layer with higher ionic conductivity. Meanwhile, a scalable coating approach is highly desired to ensure a stable interface with fast interfacial conductivity.

Herein, we report a highly scalable and effective interface engineering on a high-energy cathode NMC with a thin amorphous Li_{0.35}La_{0.5}Sr_{0.05}TiO₃ (LLSTO) solid electrolyte layer to stabilize the NMC-thiophosphate SEs interface, achieving ASLBs with an outstanding voltage window, high capacity, and the longest known cycling performance to date. The LLSTO with ionic conductivity of 8.4×10⁻⁵ S cm⁻¹ at 30° C. is in situ coated to the NMC surface via wet chemical method. The argyrodite Li₆PS₅Cl with high room-temperature ionic conductivity of ˜2×10⁻³ S cm⁻¹ is selected as the sulfide SE. The degradation of Li₆PS₅Cl at high oxidation voltage is in situ investigated through the Raman spectroscopy. In ASLBs with/without interface engineering, the interface stability and reaction kinetics are also studied, combined with the first-principles thermodynamic calculations. As a result, the thiophosphate-based ASLBs exhibit an outstanding voltage window with the longest cycling number so far.

A variety of cathodes that include lithium are suitable for use coating as described herein. One example cathode is LiCoO₂. In some instances, the cathode further includes nickel (Ni), manganese (Mn), cobalt (Co), and oxygen (O). One such cathode material is LiNi_{1/3}Mn_{1/3}Co_{1/3}O₂ (NMC 111). Other such cathode materials are LiNi_{0.5}Mn_{0.1}Co_{0.1}O₂ (NMC 811) and LiNi_{0.5}Mn_{0.3}Co_{0.2}O₂ (NMC 532).

### Results and Discussion

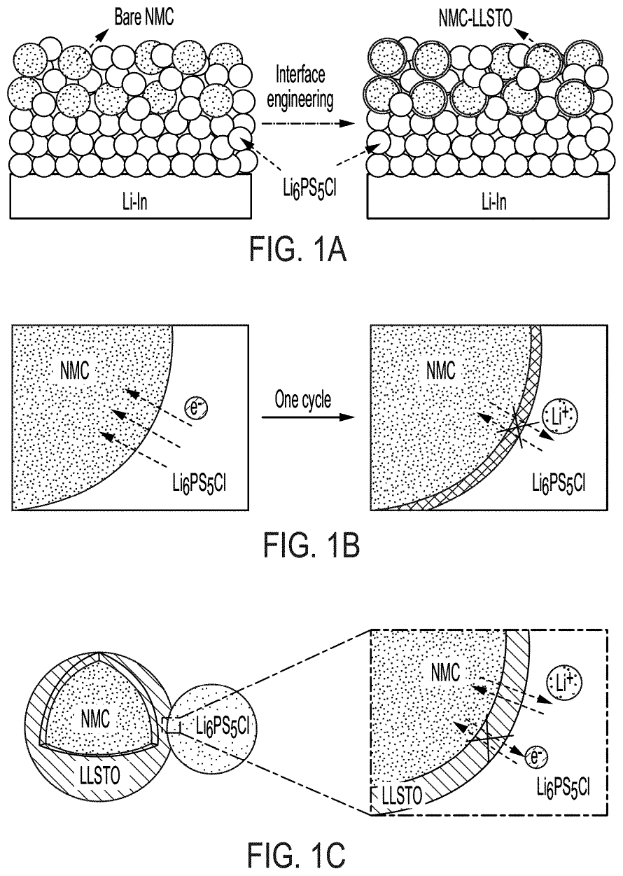

FIGS. 1A-C schematically illustrates the basic configuration of ASLBs, the interface failure mechanism between NMC and Li₆PS₅Cl electrolyte, and the interface stabilization with well-designed interface engineering. Bulk-type ASLBs with layered architecture are assembled, as shown in FIG. 1A. The cathode layer is composed with active material (bare NMC or NMC coated with LLSTO (NMCLLSTO)) and SE with no conductive additives. To avoid the interface reaction between Li and SEs, Li—In is utilized as the anode material. In ASLBs without engineering, Li₆PS₅Cl is directly in contact with NMC (FIG. 1). In the initial charge process, NMC oxidized Li₆PS₅Cl at high oxidation voltage and formed poor ionic-conductive products at the interface. This passivated layer leads to a huge capacity loss and sluggish reaction kinetics which limits the power density of the ASLBs. Therefore, a high ionic-conductive but electronic-insulate LLSTO layer was introduced at the interface between NMC and Li₆PS₅Cl, as illustrated in FIG. 1C. The LLSTO layer is stable with NMC and has a higher oxidation potential. The insulation between NMC and Li₆PS₅Cl could avoid the degradation of Li₆PS₅Cl, which stabilize the Li₆PS₅Cl to higher voltage. Meanwhile, the outstanding ionic conductivity of LLSTO and intimate contact between NMC and Li₆PS₅Cl enable enhanced reaction kinetics.

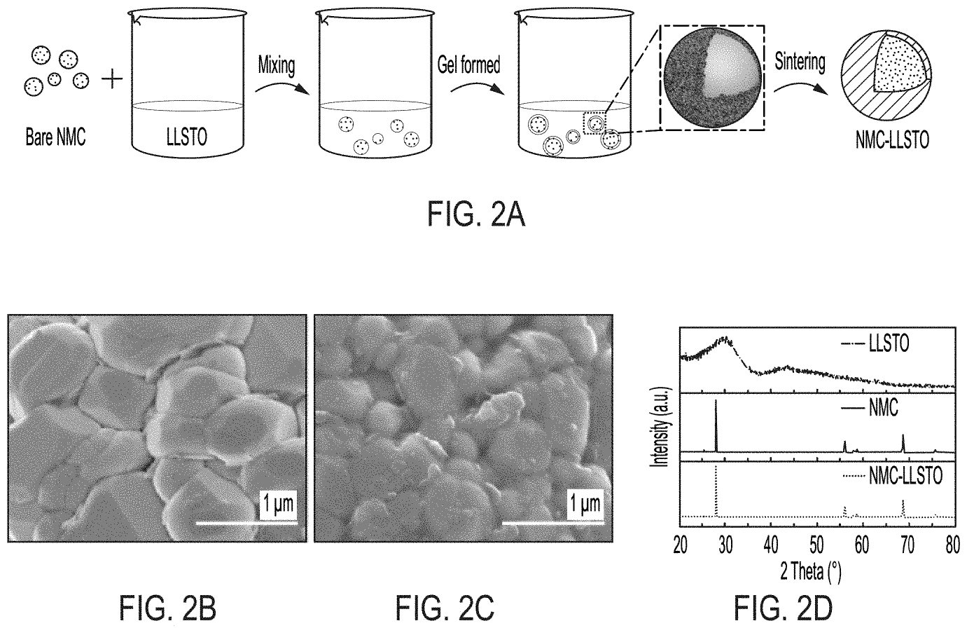

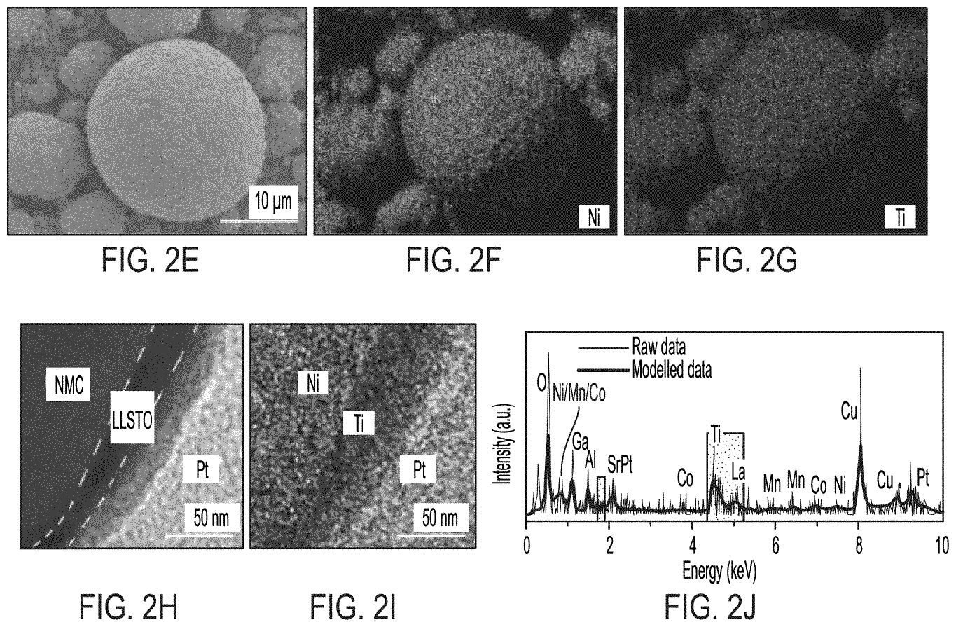

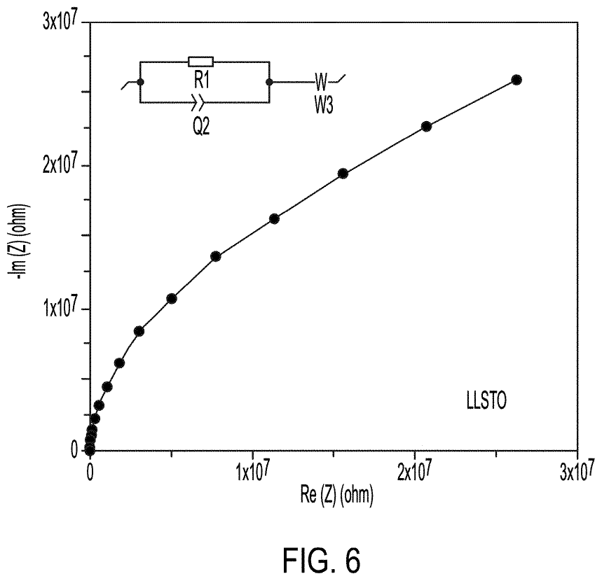

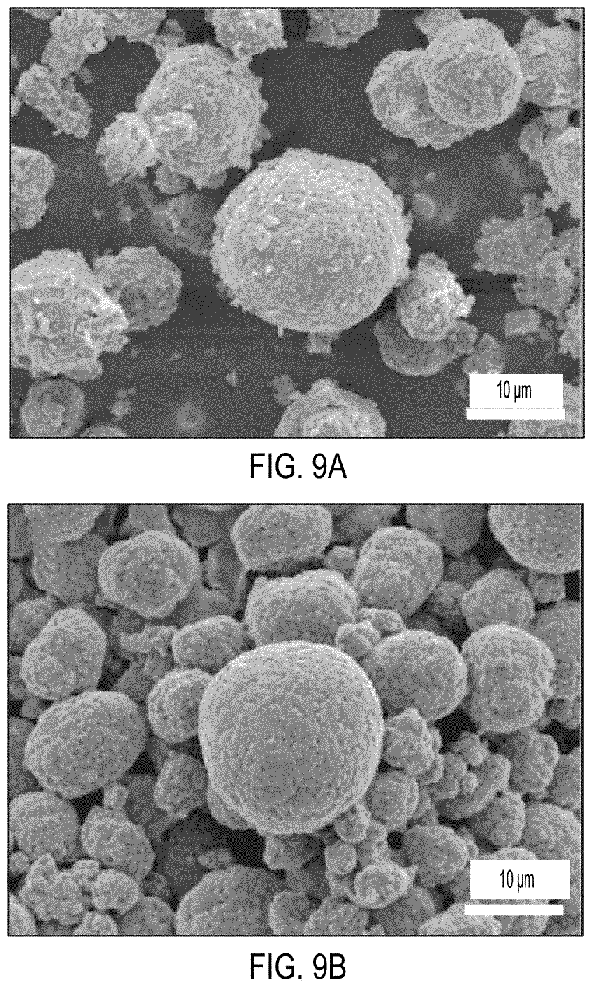

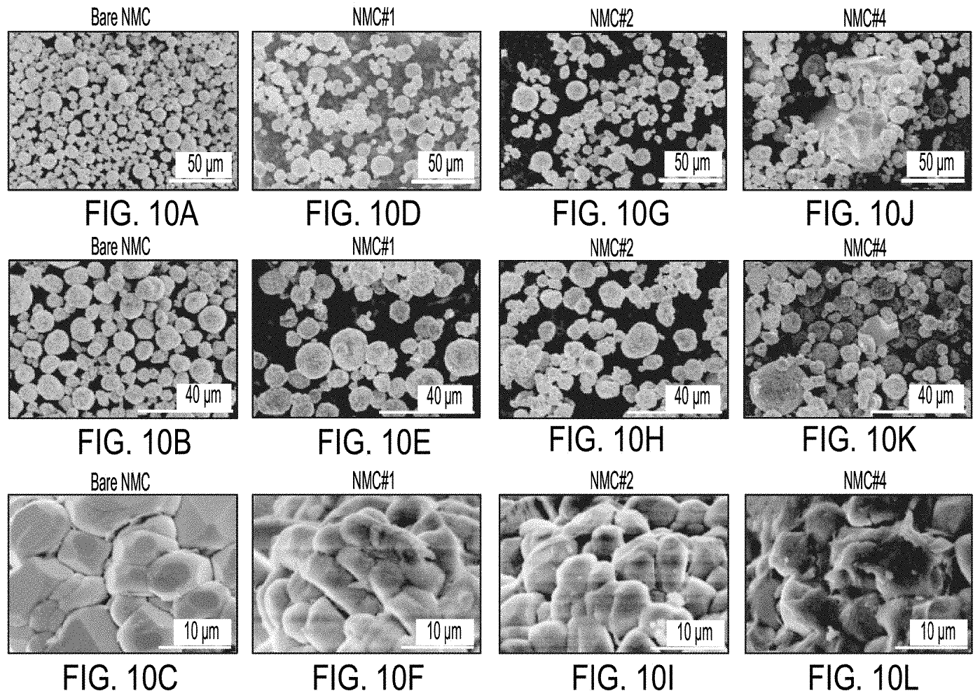

The preparation of NMC-LLSTO is a typical wet-chemical method, which is illustrated in FIG. 2A. Briefly, NMC powders were first soaked in the precursor solution of LLSTO with sufficient mixing. After the gel formation, NMC with homogeneous gel coating was collected. Followed by sintering in the air, the residual organic precursor was removed and a thin layer of LLSTO was formed at the NMC surface. The gelforming process is vital for achieving a conformal coating (FIG. 9). The thickness of the coating layer was well adjusted by controlling the ratio of NMC to LLSTO precursor. As depicted in FIG. 10 and Table 1, a conformal coating on NMC is fabricated when the amount of LLSTO is lower than 0.5 mmol in 2.0 g NMC. When further increasing the concentration, a large impurity appeared, which can be concluded as the formation of the crystallized LLSTO. Scanning electron microscopy (SEM) was used to investigate the morphology of NMC before (FIG. 2B) and after coating (FIG. 2C). It is clear that a thin amorphous layer uniformly covered the surface of NMC particles. FIG. 2D gives the Xray diffraction signals of pure LLSTO, bare NMC, and NMCLLSTO. Compared with high crystallinity of NMC, LLSTO exhibits weak and broadened peaks, which indicates its amorphous state. As a result, all peaks in NMC-LLSTO are indexed to the NMC, and there are no new phases detected, which suggests the LLSTO coating layer remains amorphous and has no side effects on the structure of NMC during the coating process. Elementary mapping analysis, presented in FIGS. 2E-G, further confirms the homogeneous coating of LLSTO on NMC. Furthermore, after a thinning process on NMC-LLSTO with focused ion beam, the transmission electron microscopy (TEM) image (FIG. 2H) and corresponding elementary mapping (FIG. 2I) in the cross-section view show that the thickness of the LLSTO coating is around 15-20 nm. The existence of peaks that belong to Ti, La, and Sr in the energy dispersive spectrum (EDS) further certified the composition of the layered coating as LLSTO (FIG. 2J). The ionic conductivity of the amorphous LLSTO is around 8.4×10⁻⁵ S cm⁻¹ at 30° C., which is measured with the same method described in previous work (FIG. 6).²⁵

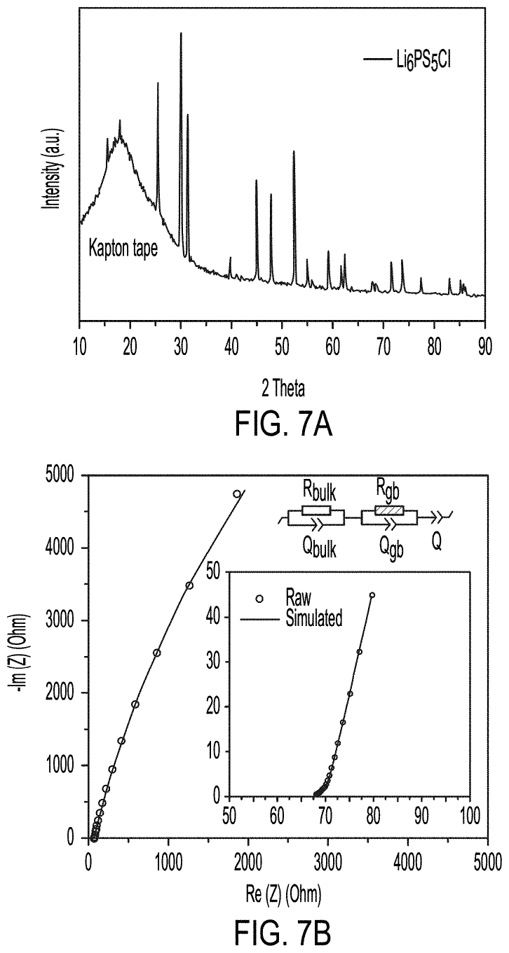

The application of high voltage cathode is highly dependent on the electrochemical stability window (ESW) of SEs. For a long time, SEs were believed to have a wide stability window of 0-5 V from cyclic voltammetry (CV) measurements based on the Li/SE/Pt setup. However, much work in experiment and theory has proved their rather narrow ESW, especially the thiophosphate-based SEs.26 High-crystalline argyrodite Li₆PS₅Cl was prepared (FIG. 7A) and utilized as the SE for ASLBs, which exhibits a high ionic conductivity of 2×10⁻³ S cm⁻¹ at room temperature. As shown in FIG. 7B, we fitted the raw data with an equivalent circuit consisting of two parallel constant phase elements (CPEs)/resistors, representing the bulk and grain boundary resistances, in series with a CPE, representing the blocking electrodes. The resulting bulk resistance is 67±1Ω, which is in accordance with the inception value directly read from the alternating current (ac) impedance. The small semicircle represents the low grain boundary resistance. The steep linear spike at low frequencies indicates a behavior of typical ionic conductor.

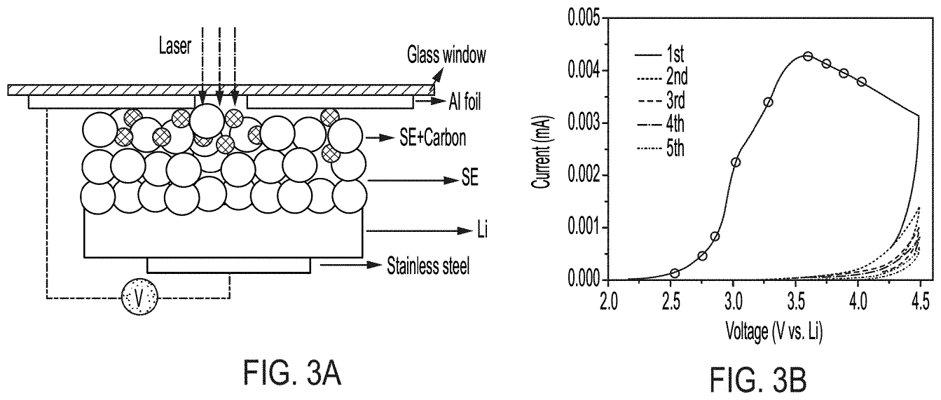

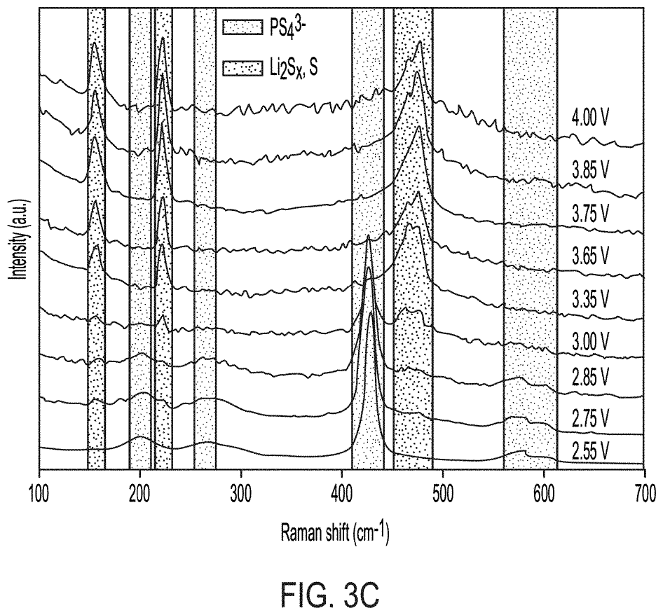

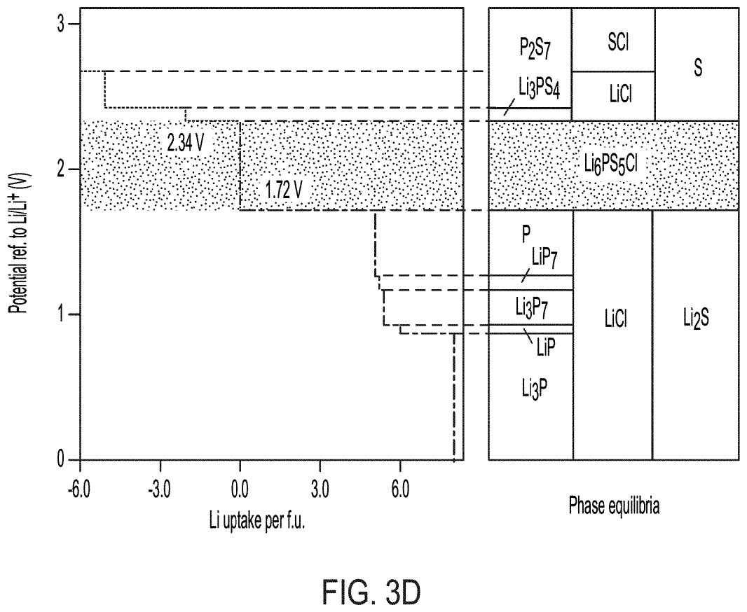

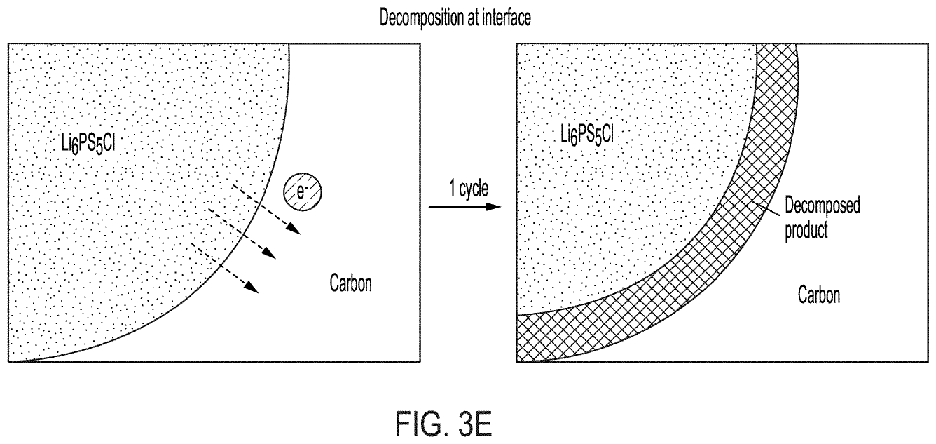

Furthermore, we investigated the in situ behavior of the Li₆PS₅Cl at high voltage with the assistance of Raman spectroscopy. FIG. 3A illustrates the cell setup for the Raman investigation. To amplify the decomposition signal of SE for better detection, SE mixed with carbon was chosen as the cathode material. A transparent glass window was employed to seal the cell and allow the laser to transmit. CV measurement was performed between 3.0 to 4.5 V (vs Li⁺/Li), which is a typical working range of a high voltage cathode (FIG. 3B). It is obvious that drastic oxidation occurs starting at around 2.3 V. This result agrees well with the thermodynamic onset of oxidation calculated to occur at 2.34 V, as obtained by first-principles thermodynamic calculations (FIG. 3D).14 Several oxidation peaks located at around 3.0, 3.6, and 4.0 V are also detected. It is interesting that there are no reduction peaks during the discharge process and no further oxidation occurred in the following cycles which suggests that the degradation products are electrochemically stable in this voltage range. FIG. 3C shows the Raman spectra of the Li₆PS₅Cl at different charged potentials from 2.55 to 4.0 V. Initially, peaks located at 203, 269, 428, 577, and 602 cm⁻¹ are attributed to the tetrahedral PS₄³⁻ unit in argyrodite-type Li₆PS₅Cl.^{27,28} During charging, all of these peaks gradually vanished, suggesting the decomposition of Li₆PS₅Cl. As a result, newborn peaks at 156, 223, and 476 cm⁻¹ are assigned to the S—S bond in Li polysulfide and sulfur which confirm the peaks in the CV coming from the gradual oxidation of S²⁻ to sulfur²⁹ and agree with thermodynamic calculations of the phase equilibria as voltage increased (FIG. 3D). Both Li polysulfide and sulfur have poor electronic and ionic conductivities, serving as passivation layers which avoid further degradation of Li₆PS₅Cl after the first cycle. This result explains why no oxidation peaks appear in the following cycles. The decomposition of Li₆PS₅Cl at high voltage is depicted in FIG. 3E. Because of the addition of carbon, the electronic conductivity of the entire cathode is greatly enhanced, which can accelerate the oxidation of S²⁻ in Li₆PS₅Cl at high voltage. As a result, a layer of decomposed products is formed at the interface between the Li₆PS₅Cl and carbon. We conclude that Li₆PS₅Cl is unstable at high voltage (>3 V), whereas the corresponding products at the interface kinetically inhibit further reaction to some extent. However, due to the poor ionic conductivity the decomposed products increase the ion transport resistance in the cathode which sacrifices the cell performance. Therefore, an interface layer can effectively stabilize SEs at high voltage, and it is desired with high ionic conductivity but electron insulation.^{14,30}

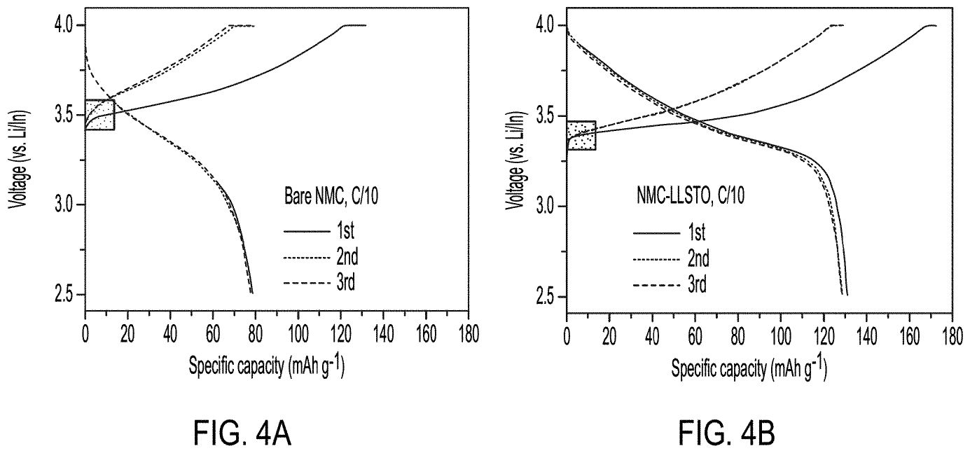

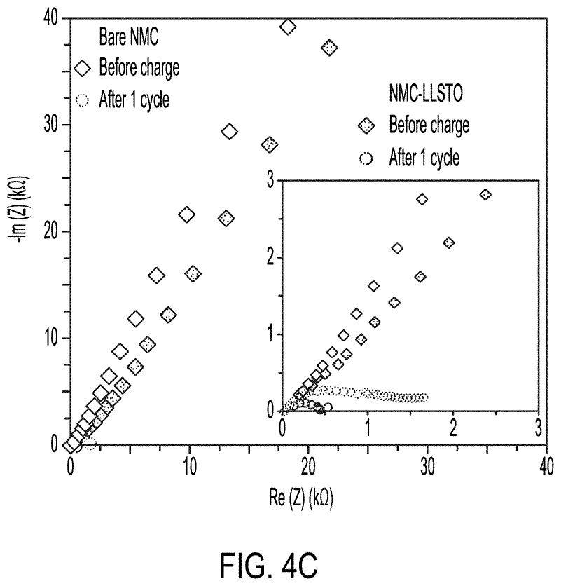

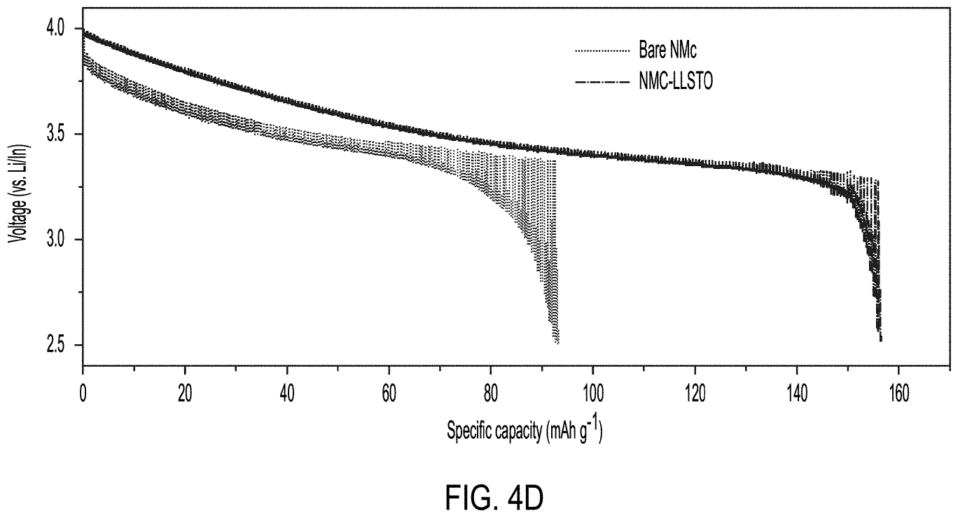

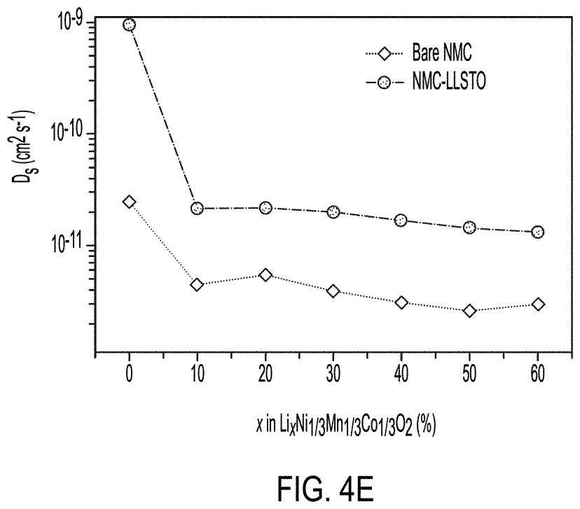

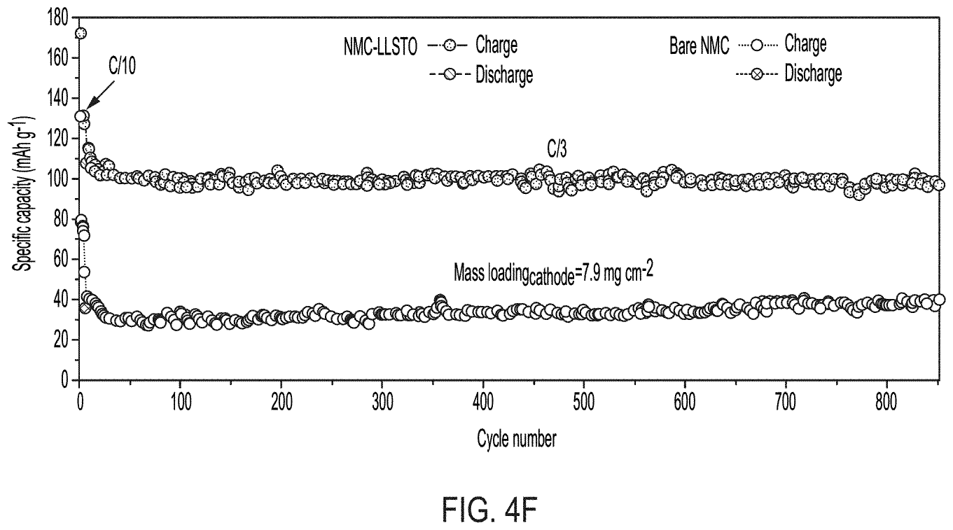

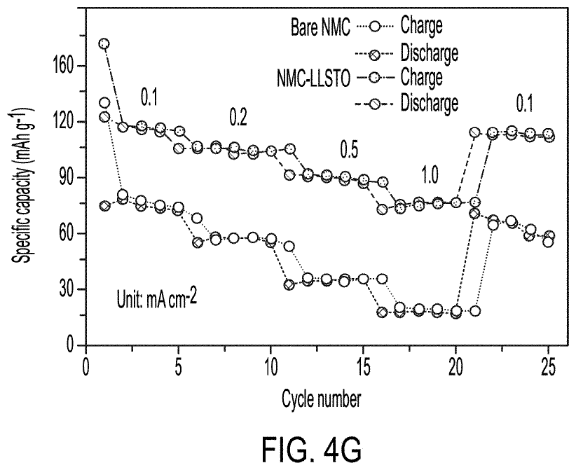

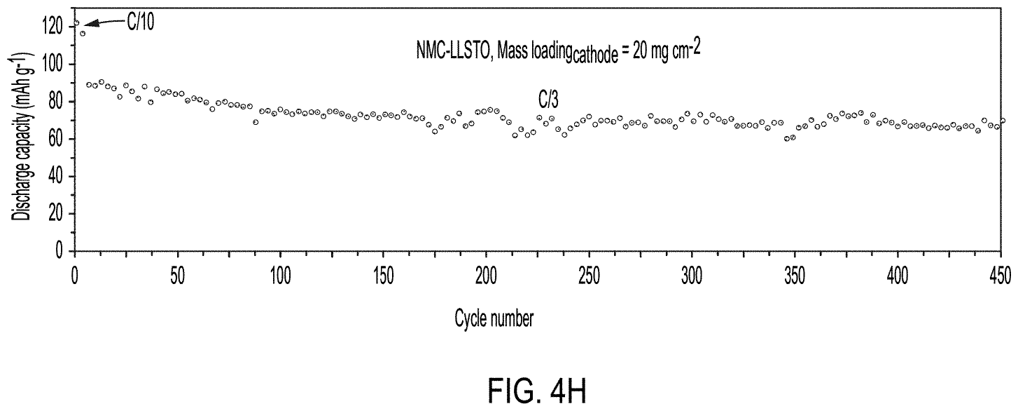

To further verify the significance of the interface engineering, the electrochemical performance of bare NMC and NMCLLSTO is explored in ASLBs. In the cathode part, to eliminate the degradation caused by carbon, there are no conductive additives. Li—In is selected as the anode to avoid the side reaction between Li₆PS₅Cl and Li metal. After assembled, all ASLB testings are performed at room temperature. FIGS. 4A-B compare the charge and discharge profiles of bare NMC and NMC-LLSTO in the first three cycles at C/10, respectively. In the initial charging process, bare NMC exhibits a much higher overpotential than NMC-LLSTO, which can be due to the interface impedance caused by slight chemical reactions between NMC and Li₆PS₅Cl and the space charge layer effect. During cycling, the LLSTO layer could effectively avoid the decomposition of Li₆PS₅Cl and the reaction with NMC. As a result, NMC-LLSTO delivers a high discharge specific capacity of 130 mAh g⁻¹, whereas bare NMC only shows that of 80 mAh g⁻¹. The initial Coulombic efficiency is also increased from 61% to 76%. In the following cycles, it is obvious that there is significant overpotential increase (highlighted in FIG. 4A) in bare NMC compared with the first charging process which comes from the increased interface resistance caused by the decomposed products in the first cycle. In contrast, this phenomenon is successfully eliminated in NMC-LLSTO (highlighted in FIG. 4B). Nyquist plots of the ASLBs with bare NMC and NMC-LLSTO as cathodes after the first cycle are compared in FIG. 4C. Before cycling, both electrodes show incomplete semicircles followed by the Warburg tails, where the higher slope in the bare NMC electrode suggests relatively sluggish ion diffusion. After one cycle, the depressed semicircles are clear, and the bare NMC electrode exhibits a much larger amplitude than NMC-LLSTO which confirmed the formation of high-resistance interface layer in bare NMC.

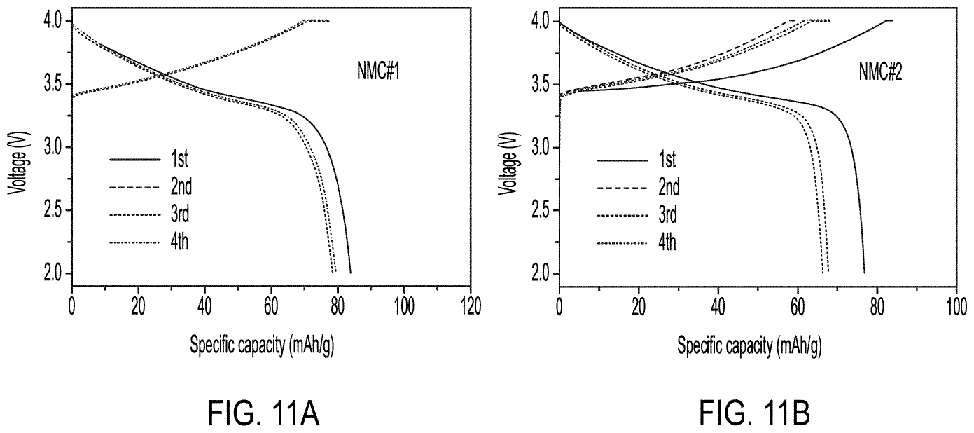

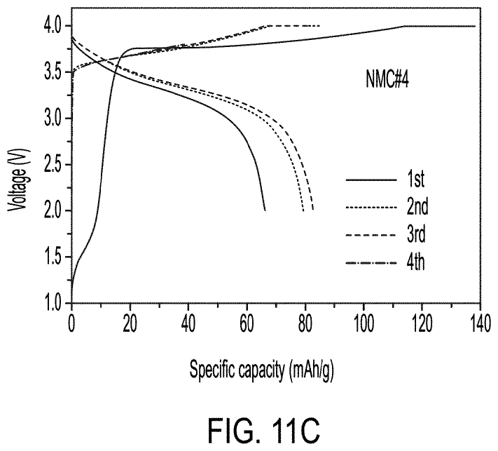

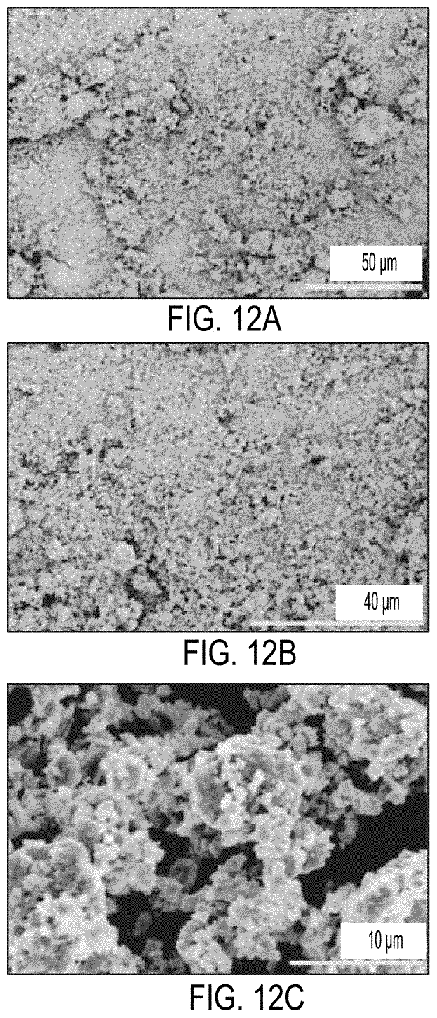

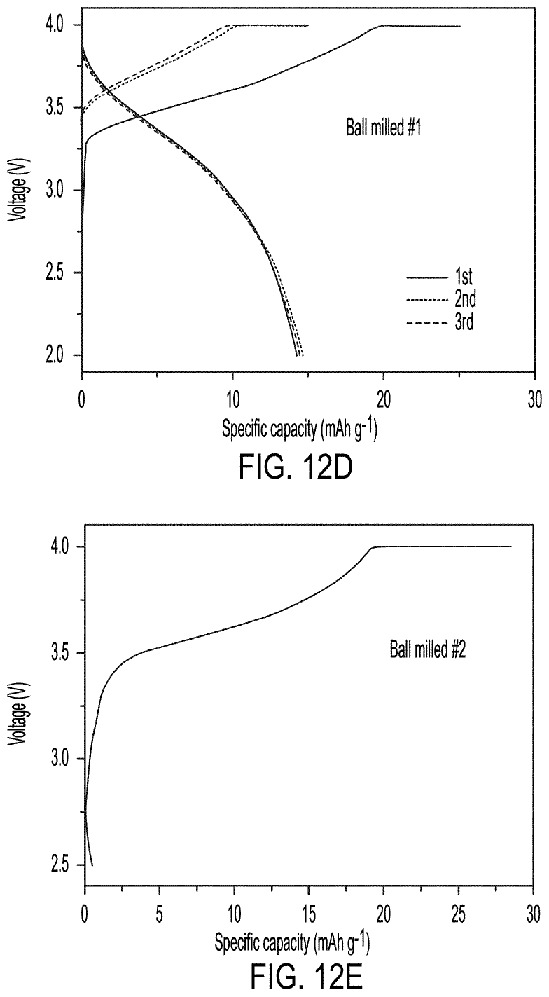

Other conditions, such as the coating thickness and particle size of NMC, also affect the performance greatly. FIG. 11 compares the full cell performances of these NMCs with different coating thicknesses. The thinner coating has an inconspicuous improvement when compared with the bare NMC. However, there is an additional oxidation plateau observed at around 1.6 V when the coating layer is thick, which can be attributed to the reaction of crystallized LLSTO. These results confirm that the coating layer with a moderate thickness (˜15-20 nm in this work) contributes to the best performance. We also compared the performance of NMC with different dimensions. A ball mill was used to adjust the NMC particle size and achieve a uniform mixture. From our data, we concluded the morphology of the NMC can be destroyed to some extent. After ball milling, the secondary particles of NMC are pulverized poorly, which exhibits poor performance even with coating (FIG. 12). To protect the second particles of NMC, moderate ball milling or even manually mixing in mortar are suggested in the preparation of NMC in full cell.

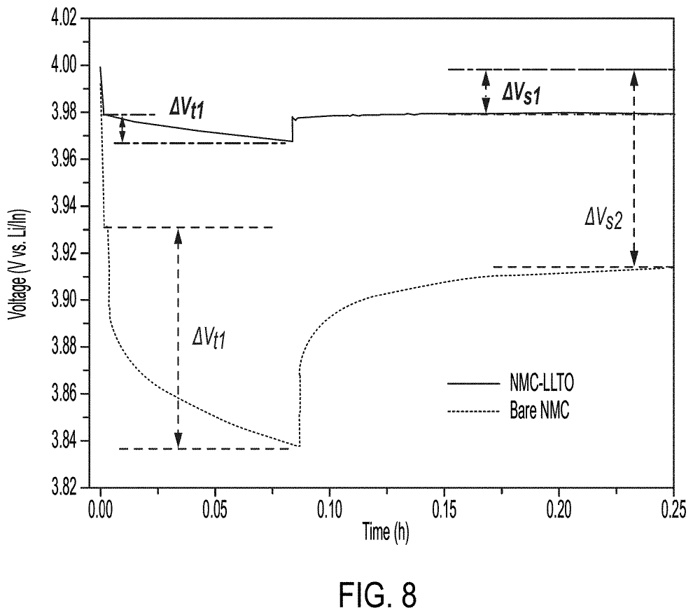

Galvanostatic intermittent titration technique (GITT) is conducted to investigate the effect of coating on solid phase diffusion kinetics in the cathode. FIG. 4D compares the transient discharge voltage profiles of bare NMC and NMCLLSTO. After introducing the LLSTO coating, the polarization is significantly lowered in the whole range and a high discharge capacity of 156 mAh g⁻¹ is obtained which confirmed the enhanced Li-ion diffusion. FIG. 4E shows the Li-ion diffusion coefficient (Ds) of bare NMC and NMC-LLSTO in different states of Li-ion intercalation (x) of Liₓ(Ni_{1/3}Mn_{1/3}Co_{1/3})O₂ (0≤x≤0.6). The D is calculated by simplified Fick's law, which is introduced in FIG. 8.²⁹ The NMC-LLSTO exhibits greatly enhanced Ds in the range of about 0.1-10×10⁻¹⁰ cm² s⁻¹, which is about five times higher than that of bare NMC. The enhanced ion diffusion in cathode can be concluded to the high ion conductivity of the LLSTO coating. In contrast, bare NMC suffers from the poor ion diffusion because of the passivated decomposed products at the interface.

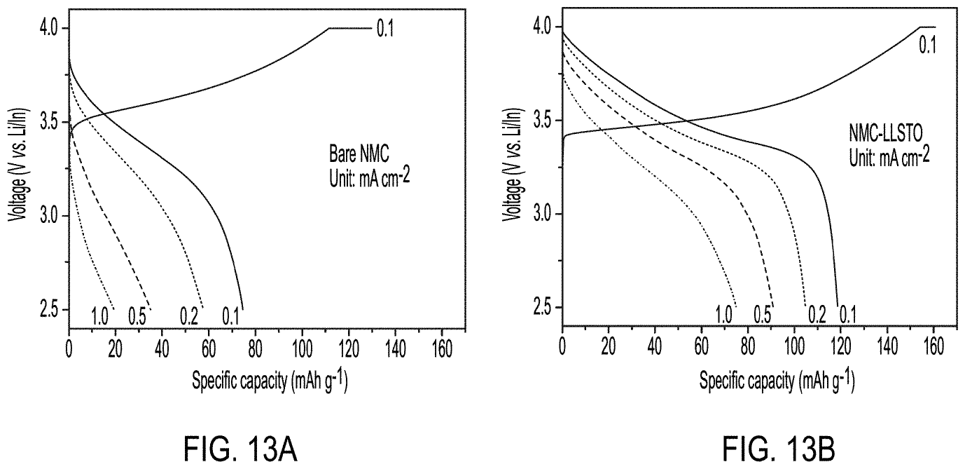

FIG. 4F shows the long-term cycling performances of bare NMC and NMC-LLSTO at C/3. Both cells are measured at C/10 for 4 cycles initially. The NMC-LLSTO displays a remarkable specific capacity of 107 mAh g⁻¹ with an ultrastable cycling for 850 cycles with a capacity retention as high as 91.5%. In contrast, bare NMC cathode shows poor cycling capacity of 30 mAh g⁻¹. It should be noted that the little vibration of capacity during cycling is caused by the environmental temperature variation. The outstanding cycling performance of NMC-LLSTO cathode confirms LLSTO is highly stable during charge/discharge process. It is no surprise that bare NMC also exhibits good cycling stability, because the passivated layer at the interface could stop the continuous reaction, as aforementioned. However, it significantly sacrifices the capacity of the NMC. FIG. 4G compares the rate performances of bare NMC and NMC-LLSTO at 0.1, 0.2, 0.5, and 1.0 mA cm⁻². NMC-LLSTO exhibits high capacity of 75 mAh g⁻¹ at 1.0 mA cm-2 (corresponding to 1.2 C), while the bare NMC shows very low capacity of 15 mAh g⁻¹. The charge/discharge profiles of both ASLBs in different rates are shown in FIG. 13. When increasing the mass loading of cathode to 20 mg cm⁻², the NMC-LLSTO still delivers a high discharge initial capacity of 122 mAh g⁻¹ at C/10, and 90 mAh g⁻¹ at C/3 and keep stable for 450 cycles. So far, the significantly improved electrochemical performances of NMCLLSTO directly stem from the interface engineering, which effectively prevented the reaction between NMC and Li₆PS₅Cl, and stabilized Li₆PS₅Cl to 4.0 V (vs Li/In) and enhances the ion diffusion in the cathode.

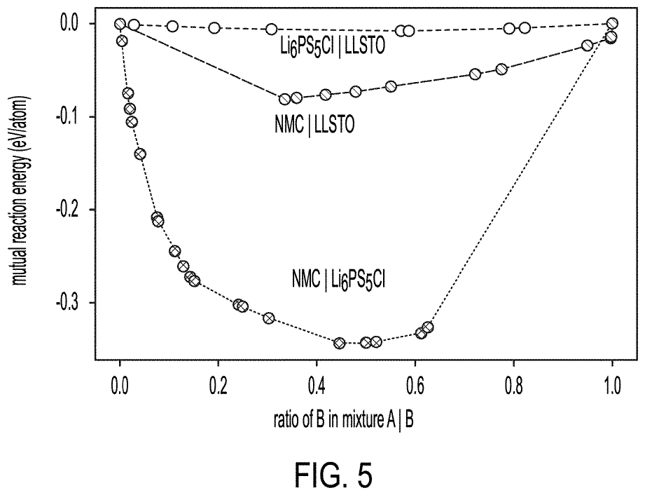

This improved interface stability of NMC-LLSTO compared to bare NMC with Li₆PS₅Cl solid electrolyte is also confirmed by the first-principles thermodynamic calculations (FIG. 5). The interfaces between NMC and Li₆PS₅Cl, NMC and LLSTO, and Li₆PS₅Cl and LLSTO were evaluated as a pseudobinary of the two contacting materials with the same scheme used in previous studies.³¹ Full details on the calculations are provided in the Experimental Section. The calculations found that the interface between bare NMC and Li₆PS₅Cl has poor stability, showing a significant decomposition energy of −0.34 eV/atom. In contrast, the interface between LLSTO and NMC is much more stable, and the most stable interface is between LLSTO and Li₆PS₅Cl, which shows a negligible reaction energy. These calculation results confirm the LLSTO coating improves the thermodynamic interface stability between NMC and Li₆PS₅Cl.

Table 2 summarized and compared the electrochemical performance of reported ASLBs using LiNi_{1/3}Mn_{1/3}Co_{1/3}O₂ as the cathode and metal sulfide as the electrolyte.³²⁻³⁷ Our ASLBs with interface engineering exhibit the longest cycling ever reported in the literature. It should be noted that in some of these works conductive carbon additives are applied in the cathode, which may optimize the performance to some extent. This work only focused on the interface stabilization between the cathode and Li₆PS₅Cl. This interface engineering approach is universal and can be implemented in a wide range of high-energy cathodes. The performance of the ASLBs can be further improved if a cathode with higher capacity is used, such as LiCoO₂ and high-Ni content NMC (LiNi_{0.8}Mn_{0.1}Co_{0.1}O₂).

In conclusion, we demonstrated an interface engineering on NMC with a thin layer of highly ionic conductive and amorphous LLSTO coating to stabilize the interface between NMC and Li₆PS₅Cl in ASLBs. The decomposition of Li₆PS₅Cl in high oxidation voltage is in situ investigated through Raman and the decomposed products at the interface, such as polysulfide and sulfur, are revealed to possess poor ionic conductivity, which caused high interface resistance. Therefore, with the protection of amorphous LLSTO, the decomposition is effectively eliminated. Compared with other reported coating materials with ionic conductivity ranging from 10⁻⁹ to 10⁻⁶ S cm⁻¹, the interface layer introduced in this work exhibits excellent ionic conductivity of 8.4×10⁻⁵ S cm⁻¹ at 30° C., which benefits the reaction kinetic and interface stability. Meanwhile, the amorphous coating promoted the interface contact and minimized the interface resistance between different layers. The superior interface stability enabled all solid NMC-LLSTO/Li₆PS₅Cl/Li—In cells with highly stable cycling performance (850 cycles with capacity retention of 91.5%) at C/3 in room temperature. The mutual reaction energy at the interface of NMC-Li₆PS₅Cl, NMC-LLSTO, and LLSTO-Li₆PS₅Cl is revealed through first-principles thermodynamic calculations. This interface engineering approach at nanometer scale can potentially be applied to other high voltage cathodes, like LiCoO₂ and high-Ni-content NMC, which can be implemented in practical application of high energy ASLBs, especially for the cathode interface stabilization in thiophosphate-based ASLBs.

### Experimental

Materials Synthesis and Preparation. LLSTO Sol Preparation

LLSTO solution is prepared based on our previous publication.²⁵ Lanthanum 2-methoxyethoxide (Alfa Aesar, 99.9%, 5% w/v in 2-methoxyethanol.), titanium isopropoxide (Aldrich, 99.9%), lithium isopropoxide (Alfa Aesar, 99.9%), and strontium isopropoxide (Sigma-Aldrich, 99.9%) are utilized as original chemicals. Briefly, lithium isopropoxide, lanthanum 2-methoxyethoxide, titanium isopropoxide, and strontium isopropoxide were mixed in a glovebox according to the stoichiometric ratio of Li_{0.35}La_{0.50}Sr_{0.05}TiO₃ (LLSTO), and 10% in mole excess lithium isopropoxide was added in order to compensate the loss during annealing. After refluxing for 2 h in Ar atmosphere, 10 mol % water was added into the system to accelerate the following gel formation.

### Coating LLSTO on NMC 111

NMC powder (MSE Supplies LLC, Tucson, Ariz., USA) was baked at 80° C. in vacuum oven for 8 h, which can prevent coating nonuniformity caused by water absorbed in NMC particles. Then the dried powder was mixed in the solution of LLSTO at a certain ratio (1 g NMC/0.25 mmol LLSTO). The suspension was stirred for 2 h in air in order to achieve uniform mixing. Afterward, the suspension was placed in the fume hood and to wait for gel formation. Then the gel was calcined in the furnace at 380° C. for 2 h in air to remove organic residues; then the temperature was raised to 500° C. for another 10 min in order to achieve full sintering. At last, the LLSTO-coated NMC 111 was ground for 10 min.

Li₆PS₅Cl Preparation

Argyrodite Li₆PS₅Cl was synthesized in a typical high-energy mechanical ball milling method and subsequent annealing treatment. A stoichiometric mixture of Li₂S (Sigma-Aldrich, 99.98%), P2S₅ (Sigma-Aldrich, 99%), and LiCl (Sigma-Aldrich, 99%) was milled in a stainless steel vacuum jar (50 mL) with 20 stainless steel balls (6 mm in diameter) for 10 h at 500 rpm under an argon atmosphere. Next, the mixture was sealed in a glass tube under argon atmosphere and annealed in a quartz tube furnace at 550° C. for 6 h.

### Materials Characterization

X-ray diffraction (XRD) measurements were carried out with X'Pert PRO system (PANalytical, Germany) with Cu Kα as the radiation source. The SEM images and EDS mapping were characterized with SEM (JEOL JSM 7000F). The thinner process of the NMCLLSTO sample was performed on a high-resolution SEM/FIBFEI Scios DualBeam system. TEM and EDS mapping images were collected on the Cs-corrected TEM/STEM-FEI Titan Themis 300. Raman spectra were measured on a Thermo Scientific DXR with 532 nm laser excitation.

### Electrochemistry Evaluation; Ionic Conductivity of LLSTO.

LLSTO sol was prepared following the standard procedure¹ then spin-coated on R-plane (110̅2) sapphire substrates at 3000 rpm (rpm) for 30 s in ambient air. Then the gel film was dried at 80° C. for 30 min on a hot plate. In addition, the dried gel films were fired at 380° C. In order to achieve a certain thickness (300 nm), this procedure may be repeated several times.

The ionic conductivity tests were conducted with electrochemical impedance spectroscopy (EIS) at Ar atmosphere. For the EIS measurement, two parallel slits of Au electrodes were sputtered on LLSTO thin films with a mask and vacuum deposition method. The test was manipulated in a Split Test Cell (MTI) which was assembled in a glovebox to avoid moisture absorption. The impedance was measured from 200 kHz to 0.1 Hz using a 100 mV ac signal by a galvanostat/potentiostat/impedance analyzer (Biologic VMP3) with a low current board. Impedance data evaluation and simulation are obtained by Z fit simulation. Ionic Conductivity of Li₆PS₅Cl

The ionic conductivity of Li₆PS₅Cl was measured using EIS by an ion-blocking symmetric system. In brief, 200 mg of grounded Li₆PS₅Cl powder was cold-pressed under 300 MPa into a pellet (0.45 mm in thickness, 12.7 mm in diameter). After that, two pieces of indium foil (11.1 mm in diameter) were pressed onto both sides of the pellet under 50 MPa. The as-prepared In/Li₆PS₅Cl/In pellet was placed in a Swagelok cell for EIS measurement, which was carried out at frequencies from 1 MHz to 100 mHz with ac amplitude of 50 mV by electrochemistry workstation (Biologic SP150). Impedance data evaluation and simulation are obtained by Z fit simulation.

Stability Investigation of Li₆PS₅Cl with In Situ Raman

The stability of Li₆PS₅Cl in the oxidation process was investigated with CV measurement, where the decomposition was in situ observed with Raman. The setup of the cell is schematically illustrated in FIG. 4A. The cathode material composed of Li₆PS₅Cl and carbon black as a ratio of 70/30 was prepared in a ball mill method. One hundred milligrams of Li₆PS₅Cl powder was cold-pressed under 300 MPa. After that, 10 mg of cathode material was cast on the pellet with a pressure of 100 MPa. A piece of Li was utilized as the anode and pressed on the other side of the pellet. The sandwiched pellets were sealed in a three-electrode cell from EC-CELL, where a piece of glass window was used to seal the cell and allowed the laser to observe the cathode part. The CV was operated between 3.0 and 4.5 V at a scan rate of 0.1 mV s⁻¹.

### Fabrication of ASLB

To prepare the cathode, NMC with/without LLSTO was manually mixed with Li₆PS₅Cl with the ratio of 70/30. One hundred milligrams of Li₆PS₅Cl was first pressed into a pellet with a diameter of 12.7 mm under 300 MPa. After that, 10 mg of as-prepared cathode was casted onto the pellet and followed pressing under a pressure of 100 MPa. The mass loading of the active material is 5.14 mg cm⁻². In the high mass loading cell, the mass loading of active material is 16.33 mg cm⁻². A piece of In—Li was pressed to the other side with a pressure of 100 MPa. Al and Cu foils were selected as the current collector in the cathode and anode, respectively. An extra pressure of 50 MPa was applied during measurement.

### Rate and Cycling Performance

The rate and cycling measurements were performed with a constant current/constant voltage protocol between the cutoff voltage of 2.5 and 4.0 V (vs Li—In), that is, the cells were charged at the constant current to 4.0 V and then held at 4.0 V for 1 h, following being discharged to 2.5 V at constant current. The current for the rate measurement was based on the area of the SSE pellet, that is, ½ in. diameter. For the long-term cycling, the cell was cycled at C/10 for five cycles, and then cycled at C/3. Here 1C means 160 mA/g based on the weight of active material in the cathode.

### GITT Measurement

All the cells were first charged for 5 min at constant current of C/20 and rested for 10 min until the voltage reached 4.0 V and then discharged for 5 min at constant current of C/20 and rested for 10 min until the voltage reached 2.5 V.

### Computation

The thermodynamic electrochemical window of Li₆PS₅Cl was calculated as in previous studies³¹ using material energies obtained from the Materials Project (MP) database³⁸ and queried using the “pymatgen package”.³⁹ The voltage profile and phase equilibria of Li₆PS₅Cl was calculated by constructing a grand potential phase diagram, which identifies the phase equilibria of the material in equilibrium with an open reservoir of Li with chemical potential μLi. The chemical potential was considered as a function of applied potential y using the relation μLi(φ)=μLi 0−eφ, where μLi 0 is the chemical potential of Li metal, and Y is referenced to Li metal, as in previous studies.^{40,41} For the interface stability calculations, we considered the interface as a pseudobinary of the two materials in contact using the same approach as defined in previous work.³¹ Using this method, at any mixing ratio between the two phases, given by a linear combination of the two parent phases normalized to one atom per formula unit, the set of phases which corresponds to the lowest energy can be identified. The mutual reaction energy is found by calculating the difference between the energy of the phase equilibria and the energy of the pseudobinary at a given mixing ratio, using the same approach as defined in our previous work.³¹

### REFERENCES

(1) Janek, J.; Zeier, W. G. Nature Energy 2016, 1, 16141.
(2) Manthiram, A.; Yu, X.; Wang, S. Nature Reviews Materials 2017, 2, 16103.
(3) Meesala, Y.; Jena, A.; Chang, H.; Liu, R.-S. ACS Energy Letters 2017, 2 (12), 2734-2751.
(4) Yue, J.; Yan, M.; Yin, Y.-X.; Guo, Y.-G. Adv. Funct. Mater. 2018, 28 (38), 1707533.
(5) Kato, Y.; Hori, S.; Saito, T.; Suzuki, K.; Hirayama, M.; Mitsui, A.; Yonemura, M.; Iba, H.; Kanno, R. Nature Energy 2016, 1, 16030.
(6) Choi, J. W.; Aurbach, D. Nature Reviews Materials 2016, 1, 16013.
(7) Chen, S.; Xie, D.; Liu, G.; Mwizerwa, J. P.; Zhang, Q.; Zhao, Y.; Xu, X.; Yao, X. Energy Storage Materials 2018, 14, 58-74.
(8) Han, F.; Yue, J.; Chen, C.; Zhao, N.; Fan, X.; Ma, Z.; Gao, T.; Wang, F.; Guo, X.; Wang, C. Joule 2018, 2 (3), 497-508.
(9) Zhou, W.; Wang, Z.; Pu, Y.; Li, Y.; Xin, S.; Li, X.; Chen, J.; Goodenough, J. B. Adv. Mater. 2019, 31 (4), 1805574.
(10) Strauss, F.; Bartsch, T.; de Biasi, L.; Kim, A. Y.; Janek, J.; Hartmann, P.; Brezesinski, T. ACS Energy Letters 2018, 3 (4), 992-996.
(11) Cui, S.; Wei, Y.; Liu, T.; Deng, W.; Hu, Z.; Su, Y.; Li, H.; Li, M.; Guo, H.; Duan, Y.; Wang, W.; Rao, M.; Zheng, J.; Wang, X.; Pan, F. Adv. Energy Mater. 2016, 6 (4), 1501309.
(12) Takada, K.; Ohno, T.; Ohta, N.; Ohnishi, T.; Tanaka, Y. ACS Energy Letters 2018, 3 (1), 98-103.
(13) Park, K. H.; Bai, Q.; Kim, D. H.; Oh, D. Y.; Zhu, Y.; Mo, Y.; Jung, Y. S. Adv. Energy Mater. 2018, 8 (18), 1800035.
(14) Zhu, Y.; He, X.; Mo, Y. ACS Appl. Mater. Interfaces 2015, 7(42), 23685-23693.
(15) Jena, A.; Meesala, Y.; Hu, S.-F.; Chang, H.; Liu, R.-S. ACS Energy Letters 2018, 3 (11), 2775-2795.
(16) Noh, S.; Nichols, W. T.; Cho, M.; Shin, D. J. Electroceram. 2018, 40 (4), 293-299.
(17) Han, F.; Zhu, Y.; He, X.; Mo, Y.; Wang, C. Adv. Energy Mater. 2016, 6 (8), 1501590.
(18) Ohta, N.; Takada, K.; Zhang, L.; Ma, R.; Osada, M.; Sasaki, T. Adv. Mater. 2006, 18 (17), 2226-2229.
(19) Zhang, J.; Zhong, H.; Zheng, C.; Xia, Y.; Liang, C.; Huang, H.; Gan, Y.; Tao, X.; Zhang, W. J. Power Sources 2018, 391, 73-79.
(20) Seino, Y.; Ota, T.; Takada, K. J. Power Sources 2011, 196 (15), 6488-6492.
(21) Sakuda, A.; Hayashi, A.; Tatsumisago, M. Chem. Mater. 2010, 22 (3), 949-956.
(22) Yubuchi, S.; Ito, Y.; Matsuyama, T.; Hayashi, A.; Tatsumisago, M. Solid State Ionics 2016, 285, 79-82.
(23) Culver, S. P.; Koerver, R.; Zeier, W. G.; Janek, J. Adv. Energy Mater. 2019, 9 (24), 1900626.
(24) Jung, S. H.; Oh, K.; Nam, Y. J.; Oh, D. Y.; Bruner, P.; Kang, K.; Jung, Y. S. Chem. Mater. 2018, 30 (22), 8190-8200.
(25) Zhang, Y.; Zheng, Z.; Liu, X.; Chi, M.; Wang, Y. J. Electrochem. Soc. 2019, 166 (4), A515-A520.
(26) Auvergniot, J.; Cassel, A.; Ledeuil, J.-B.; Viallet, V.; Seznec, V.; Dedryvare, R. Chem. Mater. 2017, 29 (9), 3883-3890.
(27) Sang, L.; Haasch, R. T.; Gewirth, A. A.; Nuzzo, R. G. Chem. Mater. 2017, 29 (7), 3029-3037.
(28) Rosero-Navarro, N. C.; Miura, A.; Tadanaga, K. J. Sol-Gel Sci. Technol. 2019, 89 (1), 303-309.
(29) Hagen, M.; Schiffels, P.; Hammer, M.; Dörfler, S.; Tubke, J.; Hoffmann, M. J.; Althues, H.; Kaskel, S. J. Electrochem. Soc. 2013, 160(8), A1205-A1214.
(30) Nolan, A. M.; Zhu, Y.; He, X.; Bai, Q.; Mo, Y. Joule 2018, 2(10), 2016-2046.
(31) Zhu, Y.; He, X.; Mo, Y. J. Mater. Chem. A 2016, 4 (9), 3253-3266.
(32) Chida, S.; Miura, A.; Rosero-Navarro, N. C.; Higuchi, M.; Phuc, N. H. H.; Muto, H.; Matsuda, A.; Tadanaga, K. Ceram. Int. 2018, 44 (1), 742-746.
(33) Sakuda, A.; Takeuchi, T.; Kobayashi, H. Solid State Ionics 2016, 285, 112-117.
(34) Kitaura, H.; Hayashi, A.; Tadanaga, K.; Tatsumisago, M. Electrochim. Acta 2010, 55 (28), 8821-8828.
(35) Machida, N.; Kashiwagi, J.; Naito, M.; Shigematsu, T. Solid State Ionics 2012, 225, 354-358.
(36) Okada, K.; Machida, N.; Naito, M.; Shigematsu, T.; Ito, S.; Fujiki, S.; Nakano, M.; Aihara, Y. Solid State Ionics 2014, 255, 120-127.
(37) Asano, T.; Yubuchi, S.; Sakuda, A.; Hayashi, A.; Tatsumisago, M. J. Electrochem. Soc. 2017, 164 (14), A3960-A3963.
(38) Jain, A.; Ong, S. P.; Hautier, G.; Chen, W.; Richards, W. D.; Dacek, S.; Cholia, S.; Gunter, D.; Skinner, D.; Ceder, G.; Persson, K. A. APL Mater. 2013, 1 (1), 011002.
(39) Ong, S. P.; Richards, W. D.; Jain, A.; Hautier, G.; Kocher, M.; Cholia, S.; Gunter, D.; Chevrier, V. L.; Persson, K. A.; Ceder, G. Comput. Mater. Sci. 2013, 68, 314-319.
(40) Mo, Y.; Ong, S. P.; Ceder, G. Chem. Mater. 2012, 24 (1), 15-17.
(41) Ong, S. P.; Wang, L.; Kang, B.; Ceder, G. Chem. Mater. 2008, 20 (5), 1798-1807.

### Supplemental Information

### 1. Ionic Conductivity of LLSTO

Ionic conductivity was assessed using electrochemical impedance spectroscopy. FIG. 6 shows representative Nyquist plots of complex impedance for the amorphous LLSTO thin films measured in an Ar atmosphere at 30° C. The spectra consist of only one semicircle or a part of one semicircle, which was asymmetric in the low frequency range. This asymmetry may be attributed to electrode contribution. In addition, the low-frequency arcs for LLSTO thin films are incomplete because of high interfacial resistance between electrode and thin film. In order to avoid any structure change to these thin films, no extra heat treatment was used to improve the adhesion between the sputtered gold electrodes and the thin films. As discussed in our previous works, the arc in the low-frequency side is associated with the electrode-film interfacial properties, while the arc in the high frequency region is attributed to the lithium ionic conduction in the thin film.

In order to determine the dc conductivities of the amorphous LLSTO thin films, the impedance response was modeled with a fitting equivalent circuit. The thin film response (the high frequency semicircle) was modeled by using a resistor (R) in parallel with a constant phase element (CPE). A Warburg element was used to describe the electrode related contributions for the impedance spectra. The thin film resistance was determined from the complex spectra by fitting experimental data to the equivalent circuit. The dc ionic conductivities were calculated from this effective dc resistance. The ionic conductivities of the amorphous LLTO thin film were obtained by the classical equation:

$$σ = \frac{1}{R} \times \frac{L}{S} \qquad ( 1 )$$

where R is the thin film resistance (Q), L is the film thickness (cm) and S is the cross-sectional area that the electric field was applied across. The conductivity at 30° C. is 8.38×10-5 S/cm for amorphous LLSTO thin films. The amorphous LLSTO exhibits a significantly higher conductivity than the un-doped amorphous LLTO.

2. XRD Patterns of Li₆PS₅Cl and Ionic Conductivity

FIG. 7A is XRD patterns of Li₆PS₅Cl. The bumped peak was derived from the Kapton tape for sample protection. FIG. 7B is Nyquist plots and fit result of Li₆PS₅Cl. Inset shows the zooming in image at high frequency and equivalent circuit.

### 3. Diffusion Calculation

The calculation of diffusion is based on the modified Fick's law in previous publication.1 Because the current rate (C/20) is fairly low for GITT, the well-known Fick's law through Equation (2) can be simplified as Equation (3). The τ is the duration time for each discharge step, and the values of ΔVs and ΔVt are extracted from FIG. 8, respectively. The Rs is the average radius of each NMC particles, which is around 4.1 μm.

$$\begin{matrix}{D}_{s} = \frac{4}{π} {{( \frac{{IV}_{m}}{{z}_{A} F S} )}^{2} [ \frac{( d E / d δ )}{( d E / d \sqrt{t} )} ]}^{2} ( t ⪡ \frac{{L}^{2}}{{D}_{s}} ) & ( 2 ) \\ {D}_{s} = \frac{4}{π} {{( \frac{{R}_{s}}{3} )}^{2} [ \frac{Δ {V}_{s}}{Δ {V}_{t}} ]}^{2} ( τ ⪡ \frac{{R}_{s}^{2}}{{D}_{s}} ) & ( 3 )\end{matrix}$$

### 4. Optimization of Coating Conditions

In order to generate uniform LLSTO coating on NMC, the formation of gel is of vital. As shown in FIG. 9A, without the gel-forming process, the coating layer only partially covered the NMC particles, which was due to the insufficient attraction between NMC particles and LLSTO sol. Therefore, the suspension of NMC in LLSTO sol was placed in ambient air for 3 to 5 hours to form the gel. As a result, a conformal coating on the NMC was achieved due to the intimate attraction (FIG. 9B). The thickness of the coating layer can be well adjusted by control the ratio of NMC and LLSTO.

5. Morphology of NMC with Different Coating Thickness

TABLE 1
The ratio of NMC to the LLSTO in coating preparation.

| | | LLSTO | NMC:LLSTO |
|---|---|---|---|
| Sample # | NMC (g) | (mmol) | (wt %) |
| 1 | 2 | 0.25 | 2.91:1 |
| 2 | 2 | 0.33 | 3.87:1 |
| 3 | 2 | 0.50 | 5.81:1 |
| 4 | 2 | 1.00 | 11.62:1 |

6. The Electrochemical Performance of NMC with Different Coating Thickness

FIGS. 11A-C show the electrochemical performance (voltage vs. specific capacitance) of NMC with different coating thickness (Samples 1-4 of Table 1).

7. The Morphology of NMC after Ball Mill and the Corresponding Electrochemical Performance

See FIG. 12.

### 8. Charge Discharge Profiles in Rate Measurement

See FIG. 13.

### 9. Performance Comparison

TABLE 2
Electrochemical performance of reported ASSLB using
LiNi_{1/3}Mn_{1/3}Co_{1/3}O₂ (NMC111) cathode and sulfide electrolyte

| | | | | | Cycling | |
|---|---|---|---|---|---|---|
| No. | Cathode | Coating | Electrolyte | Anode | performance | Ref. |
| 1 | NMC111 | LLSTO | Li₆PS₅Cl | In-Li | 53 mA/g, | This |
| | | | | | 100 mAh/g, | work |
| | | | | | after 650 | |
| | | | | | cycles | |
| 2 | NMC111 | Al₂O₃ | Li₃PS₄ | Li_{4.4}Si | 11 mA/g, | 2 |
| | | | | | 113 mAh/g, | |
| | | | | | after 100 | |
| | | | | | cycles | |
| | | LiAlO₂ | Li₃PS₄ | Li_{4.4}Si | 11 mA/g, | 2 |
| | | | | | 124 mAh/g, | |
| | | | | | after 400 | |
| | | | | | cycles | |
| 3 | NMC111 | ZrO₂ | Li₃PS₄ | Li_{4.4}Si | 7.87 mA/g, | 3 |
| | | | | | 115 mAh/g, | |
| | | | | | after 50 | |
| | | | | | cycles | |
| 4 | NMC111 | LiNbO₃ | 75Li₂S• | In-Li | 67 mA/g, | 4 |
| | | | 25P₂S₅ | | 126 mAh/g, | |
| | | | | | after 10 | |
| | | | | | cycles | |
| 5 | NMC111 | LiNbO₃ | Li₆PS₅Br | In-Li | 15.4 mA/g, | 5 |
| | | | | | 87 mAh/g, | |
| | | | | | after 10 | |
| | | | | | cycles | |
| 6 | NMC111 | Li₄Ti₅O₁₂ | 80Li₂S• | In-Li | 16.6 mA/g, | 6 |
| | | | 19P₂S₅•P₂O₅ | | 120 mAh/g, | |
| 7 | NMC111 | LiNbO₃ | 75Li₂S | In-Li | No cycling | 7 |
| | | | 25P₂S₅ | | | |

### 10. Calculated Thermodynamic Decomposition Energies and Phase Equilibria

TABLE 3
Data for NMC | Li₆PS₅Cl pseudobinary, with ratio of Li₆PS₅Cl in pseudobinary, mutual
reaction energy between phases at the ratio, and phase equilibria at the ratio.

| ratio of | mutual reaction | |
|---|---|---|
| Li₆PS₅Cl | energy (eV/atom) | phase equilibria |
| 0.000 | 0.000 | LiMn_{0.3}Co_{0.3}Ni_{0.3}O₂ |
| 0.004 | −0.019 | Li₂MnO₃, LiCoNiO₄, Li₇Co₅O₁₂, Li₃PO₄, LiClO₄, Li₂SO₄, NiO |
| 0.016 | −0.075 | Li₂MnO₃, Li₇Co₅O₁₂, Li₃PO₄, LiClO₄, Li₂SO₄, LiCoO₂, NiO |
| 0.020 | −0.091 | Li₂MnO₃, LiCl, Li₇Co₅O₁₂, Li₃PO₄, Li₂SO₄, LiCoO₂, NiO |
| 0.024 | −0.105 | Li₂MnO₃, LiCl, Li₃PO₄, Li₂SO₄, LiCoO₂, NiO, Li₅CoO₄ |
| 0.040 | −0.140 | Li₂MnO₃, LiCl, Li₃PO₄, Ni, Li₂SO₄, LiCoO₂, NiO |
| 0.074 | −0.208 | Li₂MnO₃, LiCl, Li₃PO₄, Mn₃O₄, Ni, Li₂SO₄, LiCoO₂ |
| 0.077 | −0.213 | Li₂MnO₃, LiCl, LiMnO₂, Ni, Li₃PO₄, Li₂SO₄, LiCoO₂ |
| 0.111 | −0.244 | Li₂MnO₃, LiCl, Li₃PO₄, Ni, Co₃Ni, Li₂SO₄, LiCoO₂ |
| 0.130 | −0.261 | Li₂MnO₃, LiCl, Li₃PO₄, Ni, Co₃Ni, Li₂SO₄, Li₆CoO₄ |
| 0.143 | −0.273 | LiCl, LiMnO₂, Ni, Li₃PO₄, Co₃Ni, Li₂SO₄, Li₆CoO₄ |
| 0.149 | −0.276 | LiCl, LiMnO₂, Ni, Li₃PO₄, Co₃Ni, Li₂SO₄, Li₂O |
| 0.152 | −0.278 | LiCl, LiMnO₂, Ni, Li₃PO₄, Co₃Ni, Li₂SO₄, Li₆MnO₄ |
| 0.240 | −0.302 | LiCl, Co₉S₈, LiMnO₂, Ni, Li₃PO₄, Li₂SO₄, Li₆MnO₄ |
| 0.250 | −0.305 | LiCl, Co₉S₈, Li₃PO₄, Ni, Li₂SO₄, Li₆MnO₄, MnO |
| 0.302 | −0.317 | Ni₃S₂, LiCl, Co₉S₈, Li₃PO₄, Li₂SO₄, Li₆MnO₄, MnO |
| 0.446 | −0.344 | Ni₃S₂, LiCl, Co₉S₈, Li₃PO₄, Li₂S, Li₂SO₄, MnO |
| 0.500 | −0.343 | Ni₃S₂, LiCl, Li₃PO₄, MnO, Li₂S, Li₂SO₄, Co₂NiS₄ |
| 0.520 | −0.342 | Co(NiS₂)₂, LiCl, Li₃PO₄, MnO, Li₂S, Li₂SO₄, Co₂NiS₄ |
| 0.613 | −0.333 | Co(NiS₂)₂, MnS₂, LiCl, Li₃PO₄, Li₂S, Li₂SO₄, Co₂NiS₄ |
| 0.624 | −0.327 | MnS₂, LiCl, S₈O, Li₃PO₄, Li₂S, Co(NiS₂)₂, Co₂NiS₄ |
| 0.625 | −0.326 | MnS₂, LiCl, CoS₂, Li₃PO₄, Li₂S, Co(NiS₂)₂ |
| 1.000 | 0.000 | Li₆PS₅Cl |

TABLE 4
Data for NMC | LLSTO pseudobinary, with ratio of LLSTO in pseudobinary,
mutual reaction energy between phases at the ratio, and phase equilibria at the ratio

| ratio of | mutual reaction | |
|---|---|---|
| LLSTO | energy (eV/atom) | phase equilibria |
| 0.000 | 0.0000 | LiMn_{0.3}Co_{0.3}Ni_{0.3}O₂ |
| 0.029 | −0.0009 | SrTiO₃, La₂TiO₅, LiCoNiO₄, Li₂TiO₃, NiO, Li₇Co₅O₁₂, |
| | | Li₂MnO₃ |
| 0.107 | −0.0032 | SrTiO₃, La₂TiO₅, LiCoO₂, LiCoNiO₄, Li₂TiO₃, |
| | | NiO, Li₂MnO₃ |
| 0.191 | −0.0046 | SrTiO₃, Li(CoO₂)₂, La₂TiO₅, LiCoNiO₄, Li₂TiO₃, |
| | | NiO, Li₂MnO₃ |
| 0.307 | −0.0059 | SrTiO₃, Li(CoO₂)₂, LiCoNiO₄, Li₂TiO₃, NiO, |
| | | Li₂MnO₃, La₂Ti₂O₇ |
| 0.571 | −0.0080 | SrTiO₃, Li(CoO₂)₂, LiCoNiO₄, Li₂TiO₃, NiO, Li₂Mn₃NiO₈, |
| | | La₂Ti₂O₇ |
| 0.586 | −0.0078 | SrTiO₃, Li(CoO₂)₂, Ti₄(Ni₅O₈)₃, LiCoNiO₄, Li₂TiO₃, |
| | | Li₂Mn₃NiO₈, La₂Ti₂O₇ |
| 0.790 | −0.0052 | SrTiO₃, SrLi₂Ti₆O₁₄, Li(CoO₂)₂, LiCoNiO₄, Li₂TiO₃, |
| | | Li₂Mn₃NiO₈, La₂Ti₂O₇ |
| 0.822 | −0.0046 | SrLi₂Ti₆O₁₄, Li(CoO₂)₂, O₂, LiCoNiO₄, Li₂TiO₃, Li₂Mn₃NiO₈, |
| | | La₂Ti₂O₇ |
| 1 | 0.0000 | Li_{0.35}La_{0.5}Sr_{0.05}TiO₃ |

TABLE 5
Data for Li₆PS₅Cl | LLSTO pseudobinary, with ratio of LLSTO in pseudobinary, mutual
reaction energy between phases at the ratio, and phase equilibria at the ratio.

| ratio of | mutual reaction | |
|---|---|---|
| LLSTO | energy (eV/atom) | phase equilibria |
| 0.000 | 0.0000 | Li₆PS₅Cl |
| 0.334 | −0.0811 | LaS₂, Li₄TiS₄, Li₂S, SrS, Li₃PO₄, LiCl, Li(TiS₂)₂ |
| 0.358 | −0.0799 | LaS₂, Li₂S, SrS, Li₃PO₄, LiCl, Li₂TiO₃, Li(TiS₂)₂ |
| 0.418 | −0.0766 | LaS₂, Li₂S, Li₃PO₄, Li₂TiO₃, LiCl, Sr(LaS₂)₂, Li(TiS₂)₂ |
| 0.477 | −0.0733 | LaS₂, Li₃PO₄, Li₂TiO₃, LiCl, La₁₀S₁₉, Sr(LaS₂)₂, Li(TiS₂)₂ |
| 0.478 | −0.0733 | LaS₂, La₁₀S₁₄O, Li₃PO₄, Li₂TiO₃, LiCl, Sr(LaS₂)₂, |
| | | Li(TiS₂)₂ |
| 0.549 | −0.0678 | SrLi₂Ti₆O₁₄, LaS₂, La₁₀S₁₄O, Li₃PO₄, LiCl, Li₂TiO₃, Li(TiS₂)₂ |
| 0.721 | −0.0544 | SrLi₂Ti₆O₁₄, LaS₂, La₁₀S₁₄O, Li₃PO₄, Li₄Ti₅O₁₂, |
| | | LiCl, Li₂TiO₃ |
| 0.774 | −0.0488 | SrLi₂Ti₆O₁₄, LaS₂, Li₃PO₄, Li₄Ti₅O₁₂, Li₂TiO₃, |
| | | LiCl, La₄Ti₃(SO₂)₄ |
| 0.950 | −0.0241 | SrLi₂Ti₆O₁₄, LaS₂, Li₃PO₄, Li₄Ti₅O₁₂, Li₂TiO₃, |
| | | LiCl, La₂Ti₂O₇ |
| 0.997 | −0.0159 | SrLi₂Ti₆O₁₄, Li₃PO₄, Li₄Ti₅O₁₂, Li₂TiO₃, LiCl, |
| | | Li₂SO₄, La₂Ti₂O₇ |
| 0.997 | −0.0138 | SrLi₂Ti₆O₁₄, Li₃PO₄, LiClO₄, Li₄Ti₅O₁₂, Li₂TiO₃, Li₂SO₄, |
| | | La₂Ti₂O₇ |

### REFERENCES FOR SUPPLEMENTARY INFORMATION

1. Cui, S.; Wei, Y.; Liu, T.; Deng, W., Hu, Z.; Su, Y.; Li, H.; Li, M.; Guo, H.; Duan, Y., Wang, W., Rao, M., Zheng, J.; Wang, X., Pan, F. Advanced Energy Materials 2016, 6, (4), 1501309.
2. Okada, K.; Machida, N.; Naito, M.; Shigematsu, T.; Ito, S.; Fujiki, S.; Nakano, M.; Aihara, Y. Solid State Ionics 2014, 255, 120-127.
3. Machida, N.; Kashiwagi, J.; Naito, M.; Shigematsu, T. Solid State Ionics 2012, 225, 354-358.
4. Sakuda, A.; Takeuchi, T.; Kobayashi, H. Solid State Ionics 2016, 285, 112-117.
5. Chida, S.; Miura, A.; Rosero-Navarro, N. C.; Higuchi, M.; Phuc, N. H. H.; Muto, H.; Matsuda, A.; Tadanaga, K. Ceramics International 2018, 44, (1), 742-746.
6. Kitaura, H.; Hayashi, A.; Tadanaga, K.; Tatsumisago, M. Electrochim Acta 2010, 55, (28), 8821-8828.
7. Asano, T.; Yubuchi, S.; Sakuda, A.; Hayashi, A.; Tatsumisago, M. J Electrochem. Soc. 2017, 164, (14), A3960-A3963.

### INCORPORATION BY REFERENCE; EQUIVALENTS

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A solid-state battery comprising:
a) an anode comprising lithium (Li) and indium (In);
b) a coated cathode, wherein the cathode comprises lithium (Li), and wherein the cathode coating comprises lithium (Li), lanthanum (La), strontium (Sr), titanium (Ti), and oxygen (O); and
c) an electrolyte comprising phosphorus (P) and sulfur (S).

2. The solid-state battery of claim 1, wherein the cathode coating comprises Li_{0.35}La_{0.5}Sr_{0.05}TiO₃.

3. The solid-state battery of claim 1, wherein the cathode coating has a thickness of about 15 nm to about 20 nm.

4. The solid-state battery of claim 1, wherein the cathode coating has an ionic conductivity of about 10⁻⁴ S cm⁻¹ to about 10⁻⁵ S cm⁻¹ at 30° C.

5. The solid-state battery of claim 1, wherein the cathode comprises LiCoO₂.

6. The solid-state battery of claim 1, wherein the cathode further comprises nickel (Ni), manganese (Mn), cobalt (Co), and oxygen (O).

7. The solid-state battery of claim 6, wherein the cathode comprises LiNi_{1/3}Mn_{1/3}Co_{1/3}O₂ (NMC 111).

8. The solid-state battery of claim 6, wherein the cathode comprises LiNi_{0.5}Mn_{0.1}Co_{0.1}O₂ (NMC 811) or LiNi_{0.5}Mn_{0.3}Co_{0.2}O₂ (NMC 532).

9. The solid-state battery of claim 1, wherein the electrolyte comprises Li₆PS₅Cl.

10. The solid-state battery of claim 1, wherein the battery has a capacity of at least 100 mAh g⁻¹.

11. The solid-state battery of claim 1, wherein the battery has an initial Coulombic efficiency of at least 70%.

12. The solid-state battery of claim 1, wherein the battery retains at least 90% of its original capacity after 850 cycles.

13. The solid-state battery of claim 1, wherein the battery has a capacity retention of at least 91% at C/3.

14. The solid-state battery of claim 1, wherein the battery has a voltage window from about 2.5 V versus Li—In to about 4.0 V versus Li—In.

15. A coated cathode, wherein the cathode comprises lithium (Li), and wherein the cathode coating comprises lithium (Li), lanthanum (La), strontium (Sr), titanium (Ti), and oxygen (O).

16. A method of making a coated cathode, the method comprising:
a) forming a sol by:
i) mixing lithium isopropoxide, lanthanum 2-methoxyethoxide, titanium isopropoxide, and strontium isopropoxide in an inert atmosphere;
ii) refluxing; and
iii) adding water;
b) mixing a dried powder comprising lithium, nickel, manganese, cobalt, and oxide with the sol to form a suspension;
c) mixing the suspension;
d) allowing a gel to form; and
e) calcining and sintering the gel to form a coated cathode material.

17. The method of claim 16, wherein forming the sol comprises mixing lithium isopropoxide, lanthanum 2-methoxyethoxide, titanium isopropoxide, and strontium isopropoxide according to a stoichiometric ratio of Li_{0.35}La_{0.5}Sr_{0.05}TiO₃.

18. The method of claim 16, wherein forming the sol comprises mixing at least 10% mol excess lithium isopropoxide.

19. The method of claim 16, where forming the sol comprises adding at least 10 mol % water.

20. The method of claim 16, where the dried powder is mixed with the sol according to a ratio of 1 g NMC/0.25 mMol LLSTO.
